(19) United States
(12) Patent Application Publication
(10) Pub. No.: US 2025/0018998 A1
(43) Pub. Date: Jan. 16, 2025

(54) DUAL MOTOR HANDWHEEL ACTUATOR ASSEMBLY

(71) Applicant: ZF Automotive UK Limited, Solihull (GB)

(72) Inventors: Ari Akbar Hassan Al-Jaf, Birmingham (GB); David Julian Moule, Birmingham (GB)

(21) Appl. No.: 18/769,790

(22) Filed: Jul. 11, 2024

(30) Foreign Application Priority Data
Jul. 12, 2023 (GB) 2310708.9

(51) Int. Cl. B62D 5/04; H02K 7/14; H02K 11/33

(52) U.S. Cl. CPC B62D 5/046; H02K 7/14; H02K 11/33

(57) ABSTRACT

A dual motor handwheel actuator assembly for a vehicle includes a housing. A shaft is rotatably mounted with respect to the housing and is configured for attachment of a steering wheel at one end. A first gear is connected to and configured to rotate with the shaft. Each of first and second motors has an output driving a respective output gear. The output gears are engaged with the first gear. Each motor includes a permanent magnet motor that has the same number of poles and stators such that each motor produces the same pattern of cogging torque over a complete mechanical revolution of the motor. The system is arranged so that in an unpowered condition where both motors are undriven at least one part of one of the phases of each motor is short circuited such that both motors provided a braking torque as the driver turns the wheel. The phases that include the short are selected according to the mechanical offset of the two motors relative to the output shaft whereby the effect of torque ripple applied to the output shaft in the braking torque by the first motor is at least partially cancelled by the effect of torque ripple applied to the shaft in the braking torque by the second motor.

### RELATED APPLICATIONS

This application claims priority from GB Patent Application 2310708.9, filed 12 Jul. 2023, the entirety of which is hereby incorporated herein by reference.

### TECHNICAL FIELD

This invention relates to dual motor handwheel actuator assemblies.

### BACKGROUND

Electric motors are widely used and are increasingly common in a diverse range of applications and industrial sectors. For example, in the automotive sector it is known to provide an electrically power assisted steering system in which an electric motor apparatus applies an assistance torque to a part of a steering system to make it easier for the driver to turn the wheels of the vehicle. The magnitude of the assistance torque is determined according to a control algorithm which receives as an input one or more parameters such as the torque applied to the steering column by the driver turning the wheel, the vehicle speed and so on.

Another example of use of electric motors in automotive applications is in steer-by-wire systems. During normal use, these systems have no direct mechanical link from the hand wheel that the driver grips and the steered wheels with movement of the hand wheel by the driver being detected by a sensor and the motor being driven in response to the output of the sensor to generate a force that steers the road wheels. Such an arrangement is known as a handwheel actuator assembly. Handwheel actuator assemblies also are used or being actively considered for use in a range of non-automotive applications.

These systems rely on sensors to relay user input data at a steering wheel to control units which integrate user input data with other information such as vehicle speed and yaw rate, to deliver control signals to a primary motor that physically actuates a steering rack of the vehicle. The control units also act to filter out unwanted feedback from the front wheels and provide a response signal to a secondary electric motor at the steering wheel. The secondary motor provides the driver with the appropriate resistance and feedback in response to specific user inputs at the steering wheel to mimic the feel of a conventional steering system.

In a steer-by-wire system, a malfunction or failure of a portion of the second assembly may result in an inability to steer the vehicle. As a result, it is desirable to provide the second assembly with structure for providing at least temporary fail-safe operation. US 2006/0042858 A1 discloses steering apparatus including a steering assembly that includes a steering gear for, turning the steerable wheels of a vehicle. The steering assembly includes a steering gear and first and second drive units, each for actuating the steering gear.

GB 2579374 A discloses a steering column assembly for use with a steer-by-wire hand wheel actuator. This assembly utilises a similar dual drive system that comprises first and second motors, each having an output driving a respective output gear. Each output gear drives a first gear which is connected to and configured to rotate a shaft of the steering wheel to provide a sensation of road feel to the driver. In this example, the dual drive system is used to reduce gear rattle which can occur when the torque and direction of a motor are reversed.

Typically, these applications utilise Permanent Magnet Synchronous Motors (PMSMs) due to their impressive torque density and dynamic response times. PMSMs are conventionally designed with a slotted stator due to cost and packaging constraints.

A problem occurs with steer-by-wire arrangements, arising from the fact that the vehicle wheels are not physically connected to the steering wheel, in contrast to a conventional mechanical steering wheel arrangement. The steered wheels can only pivot through a given range of motion, and it is therefore important to limit the maximum rotation of the steering wheel so that it corresponds to the maximum extent of pivoting of the steered wheels, otherwise a driver of the vehicle would be able to rotate the steering wheel indefinitely when the steered wheels are at their maximum steering angle.

In a conventional steering system it is standard practice to provide safety systems that prevent a closed circuit forming in the motor which may make it hard to turn the hand wheel. Such braking torque would be in addition to the force needed to move the road wheels relative to the road surface. The two combined may make it impossible to turn the wheel.

With a handwheel actuator for a drive by wire system, the principal resistance that is inherent in the system is the mechanical friction that opposes the driver turning the wheel and electromagnetic drag torque. For high efficiency conversion of electrical to useful mechanical energy motors are designed to have low mechanical friction and low electromagnetic drag torque. In normal operation or in a fault condition where the motor is unpowered (cannot produce any opposing torque) the hand wheel will turn very freely and feel extremely light.

The present invention seeks to ameliorate the aforementioned problems associated with handwheel actuator assemblies.

### SUMMARY

In accordance with a first aspect of the present invention, a dual motor handwheel actuator assembly for a vehicle comprises a housing, a shaft rotatably mounted with respect to the housing and being configured for attachment of a steering wheel at one end, a first gear connected to and configured to rotate with the shaft, and first and second motors, each motor having an output driving a respective output gear, the output gears being engaged with the first gear, in which each motor comprises a permanent magnet motor that has the same number of poles and stators such that each motor produces the same pattern of cogging torque over a complete mechanical revolution of the motor, and characterised in that the system is arranged so that in an unpowered condition where both motors are undriven at least one part of one of the phases of each motor is short circuited such that both motors provided a braking torque as the driver turns the wheel, and in which the phases to include the short are selected according to the mechanical offset of the two motors relative to the output shaft whereby the effect of torque ripple applied to the output shaft in the braking torque by the first motor is at least partially cancelled by the effect of torque ripple applied to the shaft in the braking torque by the second motor.

Shorting at least one part of one phase of each motor will cause a braking torque to be provided, which ensures that the driver is presented with some resistance to turning the wheel. Without this the wheel would spin with little or no resistance making control of the vehicle feel very unnatural. By offsetting the motors the ripple that is inherent in the braking torque from one motor is at least partially cancelled by the braking torque from the other motor giving a smooth and natural feel.

The offset may be selected so as to cancel at least one known harmonic in the braking torque ripple, the harmonic comprising a periodic waveform that is produced as the motor rotates. It may be selected so as to cancel the most dominant, or most problematic, harmonic.

The assembly may include a controller which forces the short circuit in at least one phase of each motor to be present when the motors are unpowered. The controller may set the position of the switches of a bridge driver circuit for each motor to accomplish this.

The assembly may include a drive stage for each motor comprising a set of switches that are operable to connect each phase to a positive supply or to a negative supply voltage dependent on the torque demanded from the motor and the motor rotor angle, and the controller may place each motor into a condition where one or more of the switches are shorted by closing the switches.

The controller may apply a short circuit current path between the terminal connections of the motor by closing one or more of the switches of the motor drive stage, or may apply a line-line fault to each motor by controlling the switches of the bridge. The controller may apply a three phase short circuit to each of the two motors again by controlling the switches of the bridge. If there is access to the star point of a start point motor, a short may be introduced by breaking the connection of a phase to the star point.

The first aspect of the invention provides a smooth motor torque when power is removed from the motor. Having power removed is one example of a fault condition for the handwheel actuator.

In an alternative, or additionally, the invention provides an assembly which is able to allow continued operation of the handwheel actuator when there is power but where a fault has occurred in one of the motors.

Accordingly, in a second aspect the invention provides a dual motor handwheel actuator assembly comprises a housing, a shaft rotatably mounted with respect to the housing and being configured for attachment of a steering wheel at one end, a first gear connected to and configured to rotate with the shaft, and first and second motors, each having an output driving a respective output gear, the output gears being engaged with the first gear, in which each motor comprises a permanent magnet motor that has the same number of poles and stators such that each motor produces the same pattern of cogging torque over a complete mechanical revolution of the motor, and characterised in that the system includes a control circuit that is arranged so that in the event of a short circuit fault in a part of at least one phase of one of the motors that causes a torque ripple to be present in the output of the motor a second short circuit fault is deliberately introduced into at least one part of one phase of the other motor to cause that motor to generate a torque ripple that at least partially cancels the torque ripple from the first motor as seen at the shaft.

The controller may be configured to introduce a single phase short circuit of the second motor when there is a single phase short circuit fault at the first motor.

The controller may be configured to introduce a line-line short circuit of the second motor when a line-line short circuit of the first motor has occurred.

By applying the same type of fault to the second motor as occurred to the first motor then a similar ripple is obtained allowing for the best cancellation.

However in some cases of faults of the first motor the fault introduced to the second motor may be of a different type in order better to cancel the ripple.

The assembly may include means for detecting when a single-phase short circuit has occurred in one of the two motors and to force a short circuit of at least one phase of the unfaulted motor.

The motors of the assemblies of the first and second aspects of the invention may be driven by an inverter bridge having a plurality of switches and the fault condition may be deliberately induced in both motors through control of the switches of the motor drive circuit to introduce a single FET short, or a Line-line short or a three-phase short.

The two motors may be connected to the shaft such that they each rotate at the same speed and direction as the shaft rotates. This is achieved by using similar gearing between the motors and the shaft. Hence when one motor is at 0 degrees mechanical the other will also be at 0 degrees, and so on for every angle X degrees from 0 to 360 degrees.

The inventions of the first aspect and the second aspect may also be applied to assemblies in which the two motors are offset. The applicant has appreciated that an offset is beneficial where each motor generates a cogging torque as the offset can be selected to enable the cogging torque from each motor to at least partially cancel out resulting in a smoother steering feel.

Where the stators are offset, when a fault occurs in one motor the exact same fault can be simulated in the other and the two resulting torque ripples will at least partially cancel out. By exact same we mean that the fault in a phase A, B or C in one motor can be cancelled by producing the same fault in the same phase A, B or C of the second motor. This is possible because the phases are out of alignment relative to the steering shaft. The effect is the same as applying the fault to different phases when the motors are in perfect alignment relative to the steering shaft.

Where the motors are not offset, the applicant has appreciated that cancellation can be best achieved by faulting a different phase of the second motor to the phase of the first motor that is faulted—e.g. if phase A of the first motor has a short circuit fault then Phase B or C may best be shorted in the second motor.

By an offset of the relative phasing of the two motors, we mean that for any position of the shaft the mechanical angle of the two motors is not the same. For example, when one motor is at the zero degrees position the other may be at the zero degrees plus X degrees position where X is any value between 0 and 360 degrees electrical, for example 0 degrees or 180 degrees or 360 degrees electrical.

The offset may be achieved by aligning the stators offset relative to each other by a non-zero number of degrees mechanical with the rotors in alignment, or having the stators in identical alignments but having the rotors offset from each other by a non-zero number of degrees, or both the rotor and the stators are offset from each other by a non-zero number of degrees. Looked at another way, where the motors have a pattern of torque ripple and cogging torque that varies over the complete range of angles 0 to 360 degrees the two motors may be phase aligned when the patterns are aligned, and to have a relative phase difference, a phase offset, when the patterns are misaligned. The amount by which the patterns are misaligned can be expressed as an angle in degrees or radians.

The applicant has appreciated that the biggest harmonic amplitude under a single bridge switch phase short is usually the first order elec. This corresponds to third order mechanical for a common 9:6 motor topology. Additionally, the second order electrical, equal to the sixth order mech for the 9:6 motor topology is considerably high. The offset may therefore be selected to provide for cancellation in particular of one of these orders of ripple.

The assembly may include a common housing for both of the motors and the offset between the stators or rotors or both may be achieved by fixing the stators of the two motors into the housing with an appropriate orientation to provide a relative phase difference between the motors and in which the rotors are connected to the shaft so that they have the same angular electrical position.

Alternatively, the motors may be fixed to the housing such that the two stators are aligned with no relative phase difference and the rotors engage the gear wheel with a non-zero relative phase difference.

Preferably the rotor and the stator of each of the two motors are identical in topology. By this we mean they have the same number of rotor magnets or poles, and the same number of stator magnets or poles. This is beneficial in reducing the bill of materials for the assembly and simply the design of the control and drive circuits for the two motors.

The dual motor drive assembly may form part of a handwheel actuator assembly for a vehicle, where the shaft includes a fixing part whereby it can be fixed to a steering wheel or yoke.

The assembly may include a common housing for both of the motors and the offset between the stators or rotors or both may be achieved by fixing the two motors into the housing with an appropriate orientation.

Preferably the two motors are identical, which is beneficial in reducing the bill of materials for the assembly and simplifying the design of the control and drive circuits for the two motors.

The handwheel actuator assemblies of the first and second aspects of the invention may be used within an electric power steering system of a vehicle, in particular a steer by wire steering system.

### BRIEF DESCRIPTION OF THE DRAWINGS

By way of example only, a specific embodiment of the present invention will now be described with reference to the accompanying drawings, in which:

FIG. 1 shows a perspective view of an embodiment of a dual motor handwheel assembly in accordance with a first aspect of the present invention;

FIG. 2 shows in more detail the mechanical connection of the two motors to the common steering shaft;

FIG. 3 is a block diagram showing the main electrical circuit parts of the assembly;

FIG. 4 shows how the motor stator can be oriented in different angular positions to alter the phasing of any torque ripple in the motor output as seen at the steering shaft;

FIG. 5 shows the relative orientation of the stators of the two motors in the assembly of FIG. 1 where an optional offset is provided;

FIG. 6 is a diagram showing the two motor winding sets and the two drive bridges in which a fault has been intentionally applied to one phase of each motor;

FIG. 7 is a graph showing the variation in the braking (damping) torque output from one of the two motors in this fault condition;

FIG. 8 shows the total torque seen at the steering shaft for both motors for different offsets; and

FIG. 9 is a view corresponding to FIG. 6 showing a fault in one phase of one motor during normal operation and a corresponding intentional fault added to the other motor.

### DESCRIPTION

A steer-by-wire dual motor hand wheel actuator 1 comprises an external elongate metal housing 2 which encloses an elongate void. A shaft 3 to which a steering wheel (not shown) is connected passes through one end of the metal housing 2 and the end of the shaft is radially supported on bearings (not show) located at one end of the housing 2.

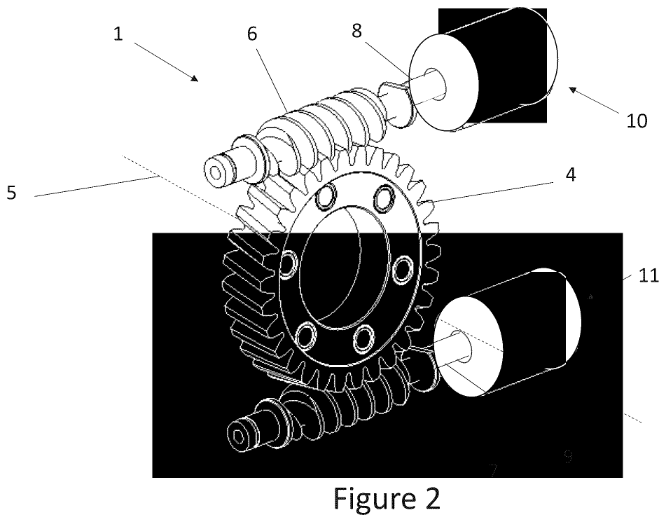

As best seen in FIG. 2 a gear wheel 4 is secured to the end of the shaft 3 and rotates with the shaft 3. The shaft is not shown in FIG. 2 but the axis of rotation of the shaft is marked using a dashed line 5, extending perpendicularly through the gear wheel 4. The periphery of the gear wheel 4 is formed as a worm gear which meshes with each of two identical worm screws 6, 7 located on opposite sides of the longitudinal axis 5 of the shaft 3. Each worm screw 6, 7 is connected to the output shaft 8, 9 of a respective electric motor 10, 11.

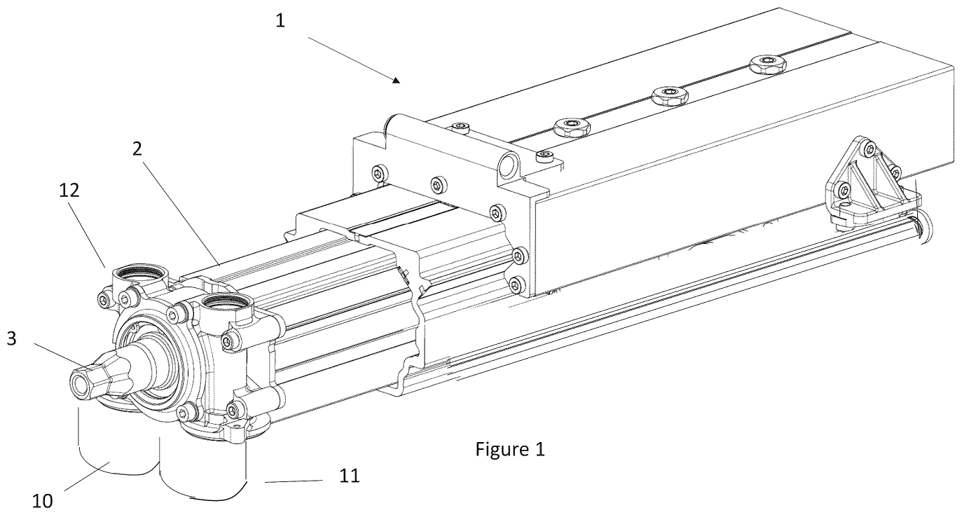

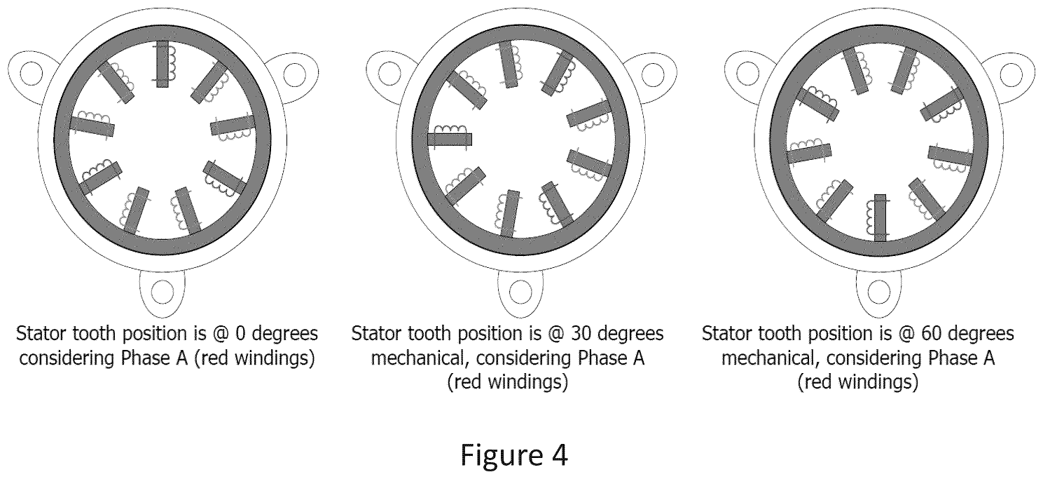

The axes of the output shafts 8, 9 of the two motors 10, 11 are arranged perpendicularly to the rotational axis of the shaft 3 and, as best seen in FIGS. 2 and 4, the axes of the two motors may also be inclined with respect to each other, to reduce the overall size of the assembly. As best seen in FIG. 1, the motors 10, are received in a transversely extending two-part extension of the housing 2.

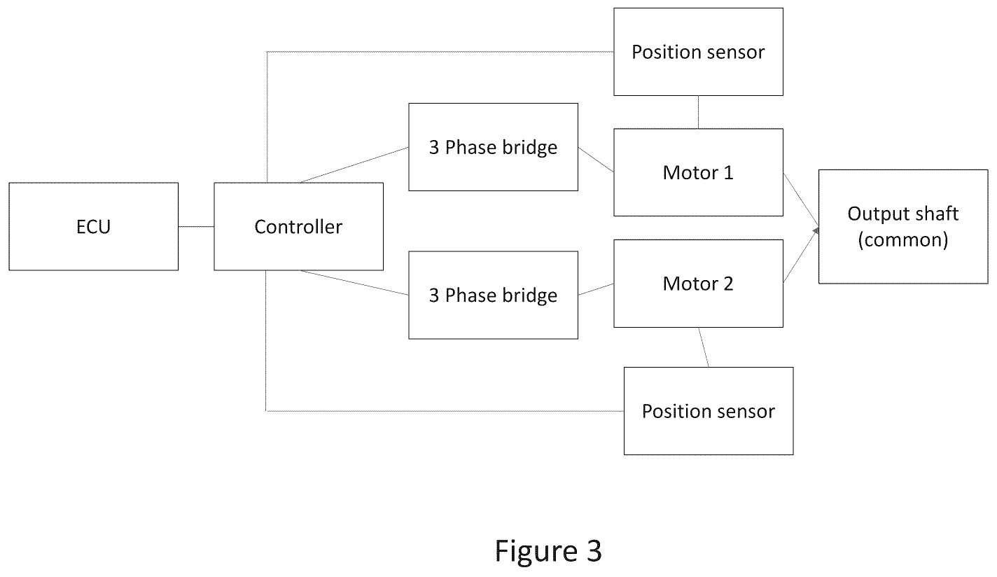

FIG. 3 shows the electrical circuit of the dual motor hand wheel actuator. Each motor in this example 10,11 has a stator winding with three phases. These phases are connected to three arms of a motor drive 3 phase bridge. Each arm has a top switch that connects the phase to a positive supply voltage when the switch is closed and a bottom switch which connects the phase to a negative, or ground, voltage. The switches are opened and closed in response to pulse width modulated signals output from a controller. The timing of these signals must be set according to the angular position of the motor rotor and hence each motor is provided with a position sensor that measures the angular position of the rotor and feeds this to the controller. The controller receives motor torque demand signals at an input from a suitable electronic control unit (ECU). These signals are what cause the motors to apply a resistance torque to the wheel that provides an appropriate steering feel as the driver turns the steering wheel.

The controller can drive the motors in a number of ways but it is preferred that they are driven so that one motor opposes the other so as to remove any freeplay present in the system. Typically one will provide a low level opposing torque of fixed value and the other will apply a varying torque that sets the overall torque applied to the handwheel.

In particular, it is preferred that the motors 10, 11 are controlled by the electronic control unit (ECU) that feeds the torque demands to the motor controller so that at low levels of input torque applied to the shaft 3 by the steering wheel, they act in opposite directions on the gear wheel 4 to eliminate backlash. At higher levels of input torque applied to the shaft 3 by the steering wheel, the motors 10,11 act in the same direction on the new wheel to assist in rotation of the shaft 3.

The use of two separate motors 10, 11 which can be controlled in a first operational mode to apply torque in opposite directions to the gear 4 eliminates the need to control backlash with precision components. In addition, the use of two separate motors 10, 11 which can be controlled in a second operational mode to apply torque in the same direction to the gear 4 allows the motors and gear components to be specified at half the rating of the required total system torque, thereby reducing the size and cost of the assembly.

As will also become apparent the use of the two motors when appropriately aligned can help to reduce unwanted torque ripple and cogging torque considerably below levels that can be achieved using a single motor of the same design and below that of a dual motor assembly in which a conventional motor alignment is used.

The arrangement of the two motors 10,11, the shaft 3, the worm gears 6,7 and the wheel gear 4 together form a dual motor electrical assembly.

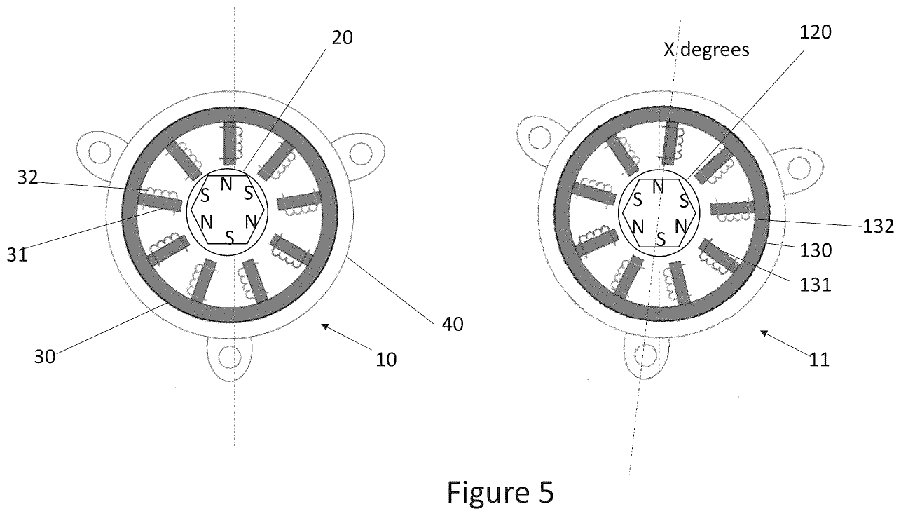

As shown in FIG. 5, the first motor 10 includes a first rotor 20, a first stator 30 and a first output shaft 8 rotatably coupled to the first rotor 20 at a first end of the first output shaft 8. The first motor 10 further includes a first case shown in which at least partially covers the first rotor 20 and the first stator 30. The first case 40 is secured to a housing which is rigidly mounted to, or integral with the elongated metal housing 2.

The motor has nine stator teeth 31 in this example, and the rotor carries six permanent magnets. Each magnet is labelled N for a north pole and S for a South pole and the North and South poles alternate around the rotor. Each stator tooth 31 is wound with electrical conductor 32 such that a current flowing through the windings around a tooth will induce a magnetic field in the teeth. The coils 32 are connected to form three motor phases, labelled A, B and C in the figures. The motor 10 is driven by an inverter which applies current waveforms to each of the three phases of the motor in a known manner. When these drive currents are applied to the phase's electromagnetic interaction between the magnetic field generated at the stator 30 and the field of the rotor permanent magnets can be used to cause the rotor 20 to rotate and for the motor 10 to generate a torque. This is applied via the Wormshaft 6 onto the gearwheel 4 and in turn the shaft 3.

Similarly, the second motor 11 includes a second rotor 120, a second stator 130 and a second output shaft 9 rotatably coupled to the second rotor 120 at a first end. The second motor 11 further includes a case as shown in FIG. 1. This case is also secured to the gearbox housing 12 which is rigidly mounted to, or integral with the elongated metal housing 2.

The second motor 11 has an identical rotor 120, stator 130 and coils to the first motor. The second motor 11 has nine stator teeth 131 in this example, and the rotor carries six permanent magnets. Each magnet is labelled N for a north pole and S for a South pole and the North and South poles alternate around the rotor. Each stator tooth 131 is wound with electrical conductor 132 such that a current flowing through the windings around a tooth will induce a magnetic field in the teeth. The coils are connected to form three motor phases, labelled A, B and C in the figures. The second motor is driven by a second inverter which applies current waveforms to each of the three phases of the motor in a known manner. When these drive currents are applied to the phase's electromagnetic interaction between the second rotor 120 and the magnetic field generated at the second stator 130 can be used to cause the rotor to rotate and for the motor to generate a torque. This is applied via the Wormshaft 7 onto the gearwheel 4 and in turn the shaft 3.

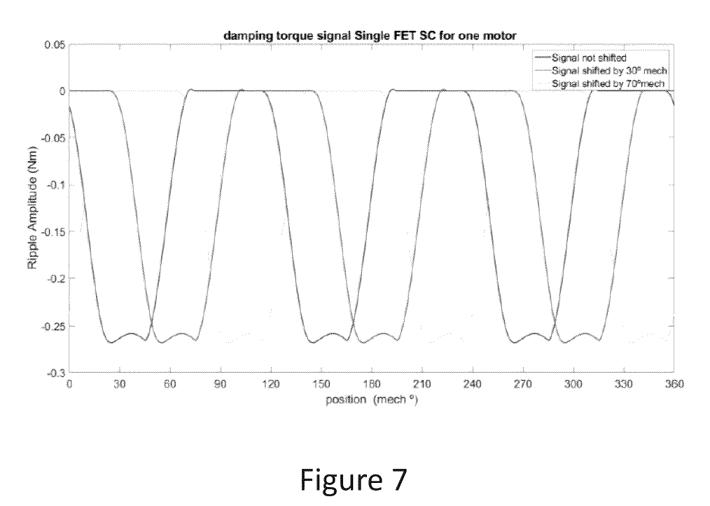

The first motor 10 and the second motor 11 may be located on diametrically opposite sides of the worm wheel 30 as shown in FIG. 1. Other positions may be used but placing them on opposing sides does provide a compact arrangement and make for convenient connections of the motor phases to the drive circuitry. An alternative arrangement is shown in FIG. 7 in which the two motors 10, 11 are arranged so that that are facing each other but offset to either side of the shaft 3.

The stators of the two motors 10,11 in this example may be aligned so that they are in phase with each other but in this first embodiment they are aligned as shown in FIG. 5 with a phase difference of X degrees between the two. By phase difference we mean that the identical patterns of cogging torque from the two motors as the shaft 3 rotates are offset This is achieved in the arrangement of FIG. 5 by careful selection of the angular position of the stators of the two motors 10,11 relative to the gearbox housing 12. When each motor is placed into the gearbox housing, care is also taken to ensure that the two rotors are perfectly aligned, with no phase difference between them. This means that for any given position of the shaft 3 the motor mechanical positions of the two motors will be offset by an amount determined by the mechanical phase difference between the two motor stators.

The applicant has appreciated that the phase offset has a significant effect on the overall cogging torque that is present at the shaft 3 because of the additive effect of the cogging torques and ripple torques from the two motors acting on the gear wheel 4. FIG. 4 shows three possible configurations giving 0 degrees, 30 degrees and 60 degrees offset by changing the orientation of the stator.

The assembly of FIG. 1 is configured to operate in two distinct fault modes as described below. The first fault mode of operation is used when the motors are unpowered, e.g. where the power supply has failed and the motors cannot be driven by to provide any torque regardless of the torque demanded by the ECU. I.

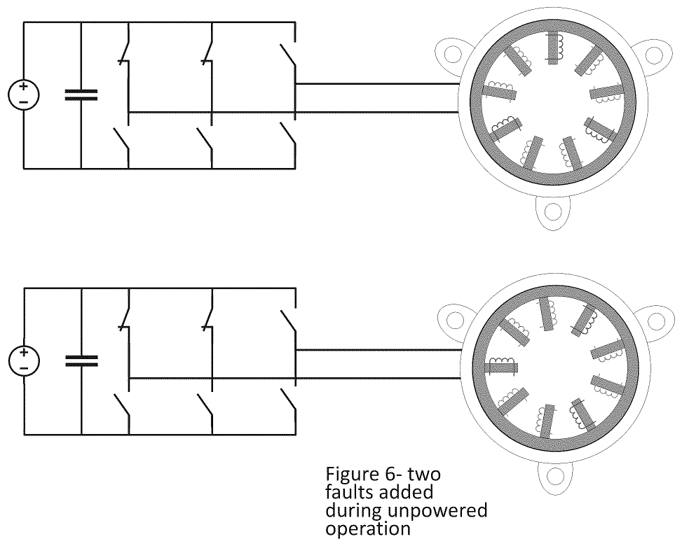

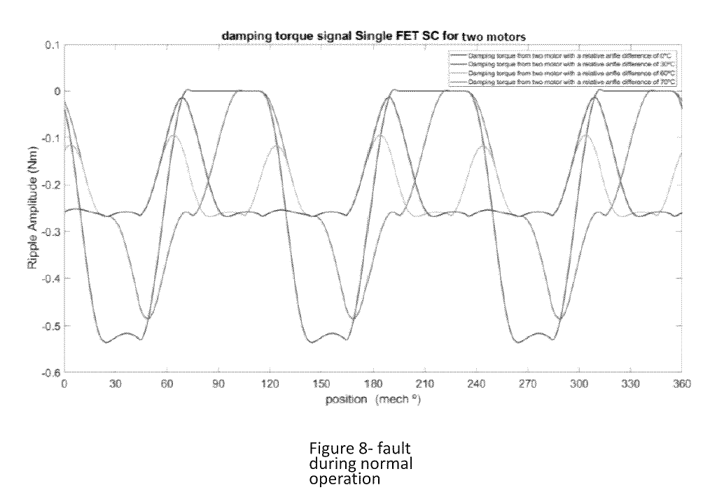

In this mode, a deliberate short circuit fault is introduced to one phase of each of the motors as shown in FIG. 6. Notably the fault in the first motor is applied to one of the phases A, B and C and the fault in the second motor is applied to a different one of the phases A,B and C. In each case, as the driver turns the wheel a braking torque will be generated around the closed loop formed by the phase and the short. This will include a ripple. FIG. 7 shows the ripple for a single motor with short circuit of one phase and how this relates to the shaft position depending on which phase has the short. Each phase is spaced in this example by 30 degrees mechanical. The second motor also provides the same braking torque and ripple as the motors are identical but this will be selected by the controller to be out of phase with the first torque ripple by an optimum amount to reduce the overall combined torque ripple. The effect of introducing a short to each of the different phases of the second motor is shown in FIG. 8. The result is that the overall braking torque ripple is reduced providing a smooth resistance to movement of the wheel by appropriate selection of the faulted phase with different reductions being achieved when different phases are faulted.

Looked at another way, the operation in this mode may be as follows:
If there is a single switch short circuit the assembly is arranged to turn the parallel on if possible and create line to line short-circuit and then create the same fault in the other motor.
If the assembly cannot turn on a parallel switch in the faulty motor unit, then the assembly may turn on a switch in the other motor of another phase.
Preferably, where possible a three-phase short circuit can be implemented on both motors by turning on all the bottom switches.

In a second fault mode of operation power is still available to the motors but a fault is present in one motor such as a single phase short circuit or a line to line fault. The motors can continue to operate but the one with a fault will provide a significant ripple. The difference between the line-line short circuit and the single switch short circuit is that they have different torque ripple orders. The single switch short circuit has 1st order electrical torque ripple and multiple of other orders such as 2nd, 3rd, etc while the 1st order is dominant and contributes to 70-80% of the ripple. The Line-line SC has 2nd order torque ripple order and it is very sinusoidal.

To compensate for this ripple, a fault such as a short circuit or a line to line fault is deliberately introduced to the second motor by the controller. The two motors then continue to be controlled in a normal manner as if the faults were not present, so that two motor torques which each have a ripple are supplied to the steering shaft.

Importantly, in this fault mode the fault that is deliberately introduced to the second motor is selected so that the ripples are out of phase and at least partially cancel out.

Where the two motors are identical and are in phase in connection to the shaft the second fault may be introduced to a different phase to that fault in the first motor to if a line-line fault or a three-phase short circuit fault cannot be achieved.

Where the two motors are already out of phase as shown in FIG. 3, the faults may be introduced of the same type in the second motor as the single switch fault or line-line fault in the first motor.

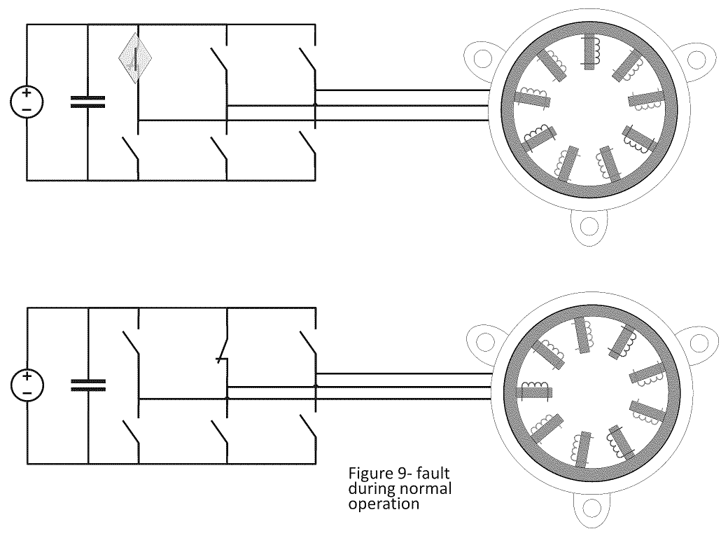

FIG. 9 shows the two motors in which a first has a single switch short circuit fault as shown in the top part of the figure and the second has had a single phase fault deliberately introduced during normal operation as shown in the bottom part.

The invention is not restricted to the details of the foregoing embodiment. The motors may have different topologies and in each case a different motor relative phasing may be used to optimise the reduction of cogging torque or of torque ripple.

1. A dual motor handwheel actuator assembly for a vehicle comprises a housing, a shaft rotatably mounted with respect to the housing and being configured for attachment of a steering wheel at one end, a first gear connected to and configured to rotate with the shaft, and first and second motors, each motor having an output driving a respective output gear, the output gears being engaged with the first gear, in which each motor comprises a permanent magnet motor that has the same number of poles and stators such that each motor produces the same pattern of cogging torque over a complete mechanical revolution of the motor, and
wherein the system is arranged so that in an unpowered condition where both motors are undriven at least one part of one of the phases of each motor is short circuited such that both motors provided a braking torque as the driver turns the wheel, and in which the phases to include the short are selected according to the mechanical offset of the two motors relative to the output shaft whereby the effect of torque ripple applied to the output shaft in the braking torque by the first motor is at least partially cancelled by the effect of torque ripple applied to the shaft in the braking torque by the second motor.

2. An assembly according to claim 1 which the selection of the phases of the two motors in which the short is introduced is performed so as to cancel at least one known harmonic in the braking torque ripple, the harmonic comprising a periodic waveform that is produced as the motor rotates.

3. An assembly according to claim 1 which includes a controller which forces the short circuit in at least one part of one phase of each motor to be present when the motors are unpowered.

4. An assembly according to claim 1 in which the parts that are shorted comprise drive switches of a motor drives stage and the controller sets the position of the switches of the bridge drive stage for each motor to accomplish this.

4. (canceled)

5. The assembly according to claim 4 in which the controller in use applies a short circuit current path between the terminal connections of the motor by closing one of the switches of the motor drive bridge, or applies a line-line fault to each motor or applies a three phase short circuit to each of the two motors.

6. A dual motor handwheel actuator assembly comprises a housing, a shaft rotatably mounted with respect to the housing and being configured for attachment of a steering wheel at one end, a first gear connected to and configured to rotate with the shaft, and first and second motors, each having an output driving a respective output gear, the output gears being engaged with the first gear, in which each motor comprises a permanent magnet motor that has the same number of poles and stators such that each motor produces the same pattern of cogging torque over a complete mechanical revolution of the motor,
and wherein the system includes a control circuit that is arranged so that in the event of a short circuit fault on at least one phase of one of the motors that causes a torque ripple to be present in the output of the motor a second short circuit fault is deliberately introduced into at least one phase of the other motor to cause that motor to generate a torque ripple that at least partially cancels the torque ripple from the first motor as seen at the shaft.

7. The assembly of claim 6 in which the controller is configured to introduce a single phase short circuit of the second motor when there is a single phase short circuit fault at the first motor.

8. An assembly according to claim 6 in which the controller is configured to introduce a line-line short circuit of the second motor when a line-line short circuit of the first motor has occurred.

9. An assembly according to claim 6 which further includes means for detecting when a single-phase short circuit has occurred in one of the two motors and to force a short circuit of at least one phase of the unfaulted motor.

10. An assembly according to claim 6 in which each motor is driven by an inverter bridge having a plurality of switches and the fault condition is deliberately induced in both motors through control of the switches of the motor drive circuit to introduce a single FET short, or a Line-line short or a three-phase short.

11. An assembly according to claim 1 in which the two motors are connected to the shaft such that they each rotate at the same speed and direction as the shaft rotates by using similar gearing between the motors and the shaft.

12. An assembly according to claim 11 in which an offset between the faults in the two motors is achieved by aligning the stators offset relative to each other by a non-zero number of degrees mechanical with the rotors in alignment, or having the stators in identical alignments but having the rotors offset from each other by a non-zero number of degrees, or both the rotor and the stators are offset from each other by a non-zero number of degrees.
